(19) United States
(12) Patent Application Publication
(10) Pub. No.: US 2010/0044441 A1
(43) Pub. Date: Feb. 25, 2010

(54) COLOR SENSING FOR A READER DEVICE AND THE LIKE

(76) Inventors: Moshe Cohen, Tel-Aviv (IL); Yossef Raichman, Herzlia (IL); Itsick Ben-Tolila, Petach-Tikva (IL)

Correspondence Address: MARTIN D. MOYNIHAN d/b/a PRTSI, INC., P.O. BOX 16446, ARLINGTON, VA, 22215, US

(21) Appl. No.: 12/530,482

(22) PCT Filed: Mar. 10, 2008
(86) PCT No.: PCT/IL08/00325

§ 371 Date: Sep. 9, 2009

(51) Int. Cl. G06K 7/12; G01J 3/46

(52) U.S. Cl. 235/469; 356/402

(57) ABSTRACT

A reader device for identifying a color property in an area of interest and presenting content in response. The reader device comprises a light source unit for emitting a number of monochromatic lights having different wavelength bands toward the area of interest and a single photoelectric sensor for intercepting a reflection of the monochromatic lights from the area of interest, thereby providing the color property output and presenting the content according to the color property.

### FIELD AND BACKGROUND OF THE INVENTION

The present invention relates to a reader device and a method for identifying a color property in an area of interest and presenting content in response and, more particularly, but not exclusively to a reader device and a method for identifying a color property of color labels and marks using a photoelectric sensor in an area of interest and presenting content in response.

In the industrial world, objects are attached with labels for automatic identification. A unique label preferably has one or more unique characteristics such as a unique pattern, a unique shape, a unique color and a unique size. It is a common practice to identify objects by information that is encrypted in the label that is attached to the object. Several methods and systems for identifying objects such as products and documents are known. An example for such a system is the widely known barcode system that is used for automating data collection where hand recording is not possible or cost effective. In such a system, a barcode, which is a machine-readable representation of information about the object in a visual format, is attached to the surface of a certain object. Originally, barcodes stored data in the widths and spacing of printed parallel lines, but today they also come in patterns of dots, concentric circles, and the data may be hidden in images. The data is read from the barcodes by optical scanners, such as barcode readers, or scanned from an image by special software. The data is displayed to the user, usually on displaying devices, or initiates a certain automatic process.

Recently, systems for identification of an object and announcing the identification details have been developed. For example, U.S. Patent Application No. 2002/0121986, published on Sep. 5, 2002 discloses a method and associated System for identification of an object and announcing via a voice message. Such a method is useful for assisting blind people in identifying objects. The method comprises steps of attaching a label, such as barcode, color-code, RFID tag or any other code on any object intended to be identified, or alternatively, using an existing code or label on the object, each object having its particular code, storing voice-messages associated with the various codes, in a memory, using a reader or a sensor to read or sense the attached code from the object, obtaining from the memory the matching voice-message according to the code, and announcing the voice-message.

During recent years, as technology moves away from gray scale imaging to color scale imaging, color sensors have become more prevalent in a many applications and systems. Such sensors are also used, inter alia, for identifying color labels that tag objects such as documents and products, as described above.

Though color sensors exist, the integration of them into such reader devices is relatively expensive. Thus, there is a need for a reader device that integrates a small and inexpensive color sensor for measuring and providing the color property of a certain label or a mark.

A variety of color sensors are well known and widely used in a variety of applications to measure color. Some color sensors illuminate an area of interest sequentially with a plurality of monochrome illuminators that emits light beams centered on different wavelengths, measure the light reflected by the area of interest to each of the monochrome illuminators, and determine the color of the area of interest based on all of the measurements. In such a manner, the color sensor obtains color information in three different regions of the spectrum.

For example, U.S. Pat. No. 6,574,425 issued on Jun. 3, 2003 discloses a modulated light source emits light to illuminate a target surface that possesses a certain color and shade of color. An optical detector detects light that is reflected from the target surface. The output from the optical detector is processed and fed back to the optical detector to compensate for any shift caused by ambient light, temperature or other external factors, and is differentially amplified to generate an output signal indicative of the color and shade of the target surface. The output signal from the differential amplifier is then demodulated by a synchronous detector to produce a substantially steady DC voltage that is indicative of the color or shade of color at the target surface. Where the target surface color shade is indicative of a certain measurable quantity or quality, such as an analyte concentration, the steady DC voltage is converted using a look-up table or mathematical formula into a corresponding quantity or quality measurement. In performing this conversion, compensation is made for any variations in modulated light source intensity due to temperature change.

Though such a color sensor provides a relatively stabile and efficient color sensor, it comprises a number of complex components. As the price of such a color sensor is relatively high, the price of a reader that integrates such a color sensor increases. Moreover, though the color sensor reduces the positional sensitivity of the instrument with respect to the area of interest, it still ignores some of the effect of positioning of the LED-based color sensor in relation to the area of interest on the interceptions of the sensing system.

There is thus a widely recognized need for, and it would be highly advantageous to have, a reader with a smaller and less expensive sensor capable of sensing more than one color.

### SUMMARY OF THE INVENTION

According to one aspect of the present invention there is provided a reader device for identifying a label having a color property. The reader device comprises a light source unit configured for emitting a plurality of substantially monochromatic light beams centered on different wavelengths toward the label a single photoelectric sensor configured for intercepting at least a portion of a reflection of each of the plurality of monochromatic light beams from the label and measuring the color property according to the portion, a processing unit for matching the color property with a content, and a presentation unit for presenting the matching content.

Optionally, the reader device further comprises a light guide unit for guiding each of the plurality of monochromatic light beams to an area of interest, the label being positioned in the area of interest.

Optionally, the light guide unit is configured for condensing each of the plurality of monochromatic light beams to the vicinity of the area of interest.

Optionally, the intercepted reflection comprises a diffuse reflection of each the plurality of monochromatic light beams, the guiding being performed in a manner that at least a portion of a specular reflection of each of the plurality of monochromatic light beams is directed away from the photoelectric sensor.

Optionally, the light guide unit comprises a light separator for blocking direct light from the light source unit.

Optionally, the light guide unit comprises a light separator for delimiting the absorption area of the photoelectric sensor.

Optionally, the plurality of monochromatic light beams are emitted in a consecutive manner.

Optionally, the light guide unit is a tubular light guide.

Optionally, the photoelectric sensor is a single photodiode.

Optionally, the light source unit comprises a plurality of light emitting diodes (LEDs) having different emission wavelengths.

More optionally, the plurality of LEDs encircle the photoelectric sensor, the device further comprising a tubular separator for preventing the single photoelectric sensor from intercepting the plurality of monochromatic light beams.

More optionally, the plurality of LEDs comprises a red LED, a green LED, a blue LED, an infrared (IR) LED, and a white light LED.

More optionally, the light source unit is configured for activating one of the plurality of LEDs for estimating the presence of the label in front of the single photoelectric sensor before the emitting.

More optionally, the light guide unit guide the light beams in a manner that the luminance distribution of the reflection of each one of the plurality of monochromatic lights relatively uniform.

Optionally, the intensity of the color property is used for determining a working mode of the reader device.

Optionally, the reader device further comprises a label detection sensor adapted for detecting the presence of a label in front of the single photoelectric sensor.

Optionally, the single photoelectric sensor further comprises a number of additional photoelectric sensors for intercepting another portion of the reflection and measuring the color property according thereto.

Optionally, the reader device is positioned in an acute angle approximately between 50° and 90° in relation to the plane of the area of interest.

Optionally, the single photoelectric sensor is configured for reducing the effect of a fluorescent illumination on the portion, the measuring being performed according to the reduction.

Optionally, the label comprises a plurality of segments each having a different color, each the monochromatic light beam is emitted toward one of the plurality of segment.

Optionally, the reader device further comprises a proximity detection element for detecting the positioning of the reader device in a proximity to the label, the proximity detection element being configured for activating at least one of the light source unit, single photoelectric sensor, and presentation unit.

More optionally, the proximity detection element is a pressure switch.

Optionally, the label comprises a plurality of segments each having a different color, the light source unit being configured for emitting the plurality of substantially monochromatic light beams toward each the segment, the single photoelectric sensor configured for measuring the color property according to light reflected from each the segment, the color property is defined according to the order of the plurality of segments.

Optionally, the label comprises a calibration segment, the single photoelectric sensor being configured for performing the measuring according to the calibration segment.

More optionally, the calibration segment having a maximal reflection of light that is centered on a certain wavelength in relation to other reflections from the label.

Optionally, the label comprises a calibration segment, the single photoelectric sensor being configured for normalizing the measuring according to the calibration segment.

According to another aspect of the present invention there is provided a color-sensing unit for measuring a color property in an area of interest. The color-sensing unit comprises a light source for emitting a light beam toward the area of interest, a photoelectric sensor, a light guide for guiding the light beam toward the area of interest in a manner such that at least a portion of a specular reflection of the light beam is directed away from the photoelectric sensor. The photoelectric sensor is configured for intercepting and measuring at least a portion of a diffuse reflection of the light beam from the area of interest, thereby providing the color property.

Optionally, the photoelectric sensor is a single photodiode.

Optionally, the light guide has a tubular shape.

Optionally, the light guide has a conical shape.

Optionally, the light guide has a shape of a longitudinal segment of a conical tube.

Optionally, the light source comprises a plurality of light sources, each source producing a light beam having a different wavelength band respectively.

More optionally, the plurality of light sources are emitted in a consecutive manner, the photoelectric sensor being configured for providing the color property according to the diffuse reflections from each of the light sources.

More optionally, the plurality of light sources comprises at least one light emitting diode (LED).

According to another aspect of the present invention there is provided a method for identifying a color property in an area of interest using a photoelectric sensor. The method comprises the following steps: a) emitting a first beam of light, b) directing the first beam toward the area of interest in such a manner that the specular reflection thereof is directed away from the photoelectric sensor, c) using the photoelectric sensor for intercepting at least a portion of a diffuse reflection of the first beam from the area of interest, and d) providing the color property according to the intercepted reflection.

Optionally, the method further comprises a step e) of presenting the content according to the color property.

Optionally, the method further comprises a step c1) of repeating step (a)-(c) using a second beam of light instead of the first beam, the first and second beams having different wavelength bands respectively.

Optionally, the photoelectric sensor is a single photodiode.

Optionally, the method further comprises detecting the presence of a label in the area of interest before the a).

More optionally, the detecting comprises emitting a preliminary beam of light toward the area of interest, using the photoelectric sensor for intercepting at least a preliminary portion of a preliminary diffuse reflection of the preliminary beam from the area of interest, and analyzing the preliminary diffuse reflection to determine the presence of a label in the area of interest.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and apparatus of the present invention involves performing or completing certain selected tasks or steps manually, automatically, or a combination thereof. Moreover, according to actual instrumentation and equipment of preferred embodiments of the method and apparatus of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and apparatus of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of a reader device for identifying a color property in an area of interest and displaying content in response, according to one embodiment of the present invention;

FIG. 2 is another schematic illustration of the reader device of FIG. 1, further depicting a light guide unit for diverting the light emitted from the light source unit, according to one embodiment of the present invention;

FIG. 3 is a schematic illustration of the light guide and exemplary illustration of the path of light that passes therethrough, according to one embodiment of the present invention;

FIG. 4A is a schematic representation of a color-sensing unit that comprises the photoelectric sensor, the light guide unit, and the light source unit of the reader device, according to one embodiment of present invention;

FIG. 4B is a sectional view of the color-sensing unit that is depicted in FIG. 4A, according to one embodiment of present invention;

FIG. 4C is a schematic representation of an upper view of the color-sensing unit that is depicted in FIG. 1, according to a preferred embodiment of present invention;

FIGS. 5A, 5B, and 5C are schematic illustrations, each from a different point of views, of another light guide, according to another embodiment of the present invention;

FIG. 6 is a sectional view of a housing that substantially encloses all the elements of the reader device and a view of the color-sensing unit 100 that is depicted in FIGS. 3 and 4, which is integrated into the housing, according to a preferred embodiment of present invention;

FIG. 7 is a schematic representation of an exemplary reader device that comprises a housing that is shaped as a writing tool with an ergonomic handle, according to a preferred embodiment of the present invention; and

FIG. 8 is a flowchart of a method for identifying a color property in an area of interest using a photoelectric sensor, such as a photodiode, according to one embodiment of the present invention.

### DESCRIPTION OF THE PREFERRED EMBODIMENTS

The present embodiments comprise a reader device and a method for identifying a label having a color property and presenting matching content in response. The reader device uses a small and inexpensive color-sensing unit. The color-sensing unit comprises a light source unit for emitting a plurality of monochromatic lights having different wavelength bands toward the label and a photoelectric sensor for intercepting at least a portion of the reflection of the lights from the label and measuring the color property of the label according to the portion. The photoelectric sensor provides a color property output, which is based on the intercepted reflection, to the reader device that uses the color property for identifying and presenting the matching content.

The present embodiments further comprise a color-sensing unit for measuring a color property output in an area of interest, which is preferably used in the aforementioned reader device. The area of interest preferably encircles or approximately encircles the aforementioned label. The color-sensing unit comprises a light source for emitting a light beam toward the area of interest, a photoelectric sensor, and a light guide for guiding the light beam toward the area of interest in a manner that at least a portion of a specular reflection of the light beam is directed away from the photoelectric sensor. The photoelectric sensor intercepts and measures at least a portion of a diffuse reflection of the light beam from the area of interest, thereby providing the color property output that may be used for identifying the label.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A content may be understood as a an audio sequence, a video sequence, an audio file, a video file, a segment of text, a multimedia content, a word, a number, a paragraph, a link, a pointer, a set of instructions, etc.

A label may be understood to include a color label, a monochrome label, a mark, a spot, a label having a unique color combination, a label having a unique shades of gray color combination, or any label which is used for associating an object, a document, an image, a file, or a page with designated content. The labels may be created on any type of printable media, such as paper, preferably using standard ink and a standard printing process. The labels may be of any shape or color of preferably a diameter as little as 0.33 inches. During the printing process or at any other time, the labels may be encoded with a unique code.

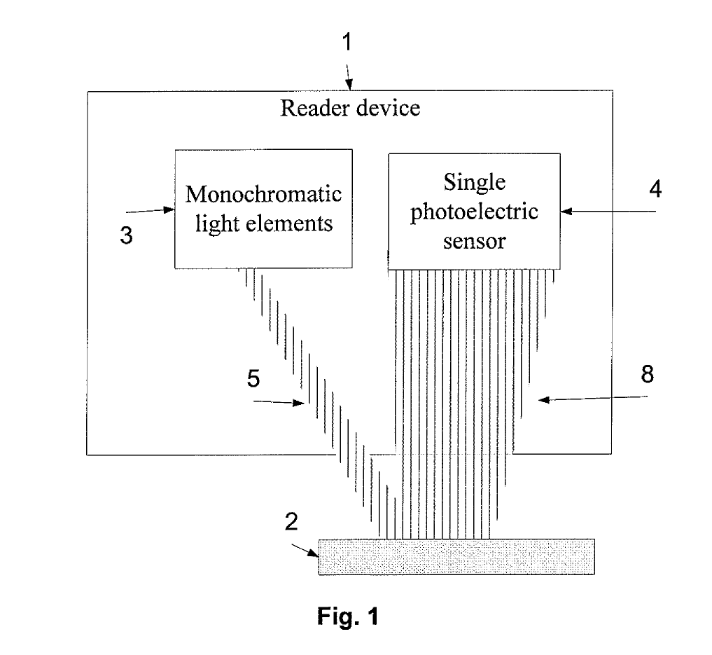

Reference is now made to FIG. 1, which is a schematic illustration of a reader device 1 for identifying a color in an area of interest 2 and presenting content in response, according to one embodiment of the present invention. The reader device 1 comprises a light source unit 3 for emitting a light beam toward the area of interest 2 and a photoelectric sensor 4, such as a single photodiode, for intercepting the reflection of the light beam from the area of interest 2. For clarity, the area of interest 2 may be understood as an area that is illuminated by the light source 2 and as an area from which the reflections of the light emitted from the light source 2 are intercepted. Preferably, unlike commonly known color sensors, the intercepted reflection is unfiltered. Preferably, the light source unit 3 emits two or more monochromatic light beams 5 having different electromagnetic radiation spectrum (ERS), such as infrared (IR), red (R), green (G), blue (B), or ultraviolet (UV). Preferably, the two or more monochromatic light beams 5 are emitted in a sequential manner. The light source unit 3 and the photoelectric sensor 4 are preferably components of a color-sensing unit (not shown) that is integrated into the reader device 1.

Preferably, each one of the monochromatic light beams 5 is generated by an independent light emitting element, such as a light emitting diode (LED). It should be noted that although only one monochromatic light beam 5 is depicted, any number of monochromatic light beams may be emitted from the light source unit 3 that preferably comprises a respective number of light emitting elements.

The photoelectric sensor 4 produces a color property output that represents an estimated color property of a label in the area of interest 2. The color property output is generated in response to the absorption of the photons of the monochromatic light beams 5, 6, 7, which are reflected from the area of interest 2. Preferably, the photoelectric sensor 4 is a photodiode that produces, as a result of the absorption of the reflected photons, a photovoltage or free carriers that support the conduction of generated photocurrent. Preferably, the photovoltage is forwarded to a processor that matches it with records from an integrated repository and identifies a matching content record. The reader device 1 preferably presents the matching content according to the photovoltage or according to any other color property output, as further described below. The presenting of the content may be understood as playing an audio file, displaying a video file, displaying a text message, activating a vibrating unit, activating a light source or changing the color of light emitted therefrom, etc.

For example, the reading device may be used in combination with a book with predefined labels, as described in a pending patent application entitled “reading device”, having international publication number WO2005/029697A2, which is incorporated herein by reference. In such an exemplary embodiment, the reader device presents a specific audio sequence in response to a color property output. The reader device generates a preprogrammed audio sequence, when the device is brought into proximity with a specific label and the specific label is in the area of interest. The audio sequence may include a narrative of a text that is provided in the book, a related song, a musical performance or a combination thereof.

In use, a user positions the reader device 1 in the proximity of the specific label in order to allow the illumination of thereof by the light source unit 3 and the interception of reflections therefrom by the photoelectric sensor 4. Preferably, the reader device 1 comprises a light guide unit (not shown) that directs the light emitted from the light source unit 3 toward the area of interest 2 in a manner that allows the user to position the reader device 1 in a wide angular range in relation to the specific label. Preferably, the light guide unit diverts the light emitted from the light source in a manner that at least a portion of the specular reflection thereof is directed away from the photoelectric sensor.

As described above, the photoelectric sensor 4 is designed to generate the color property output in response to the absorption of the photons of the monochromatic light beams 5, 6, 7, which are reflected from the area of interest 2. The absorption of the monochromatic light beams 5, 6, 7 may be affected by the illumination conditions in the surrounding of the area of interest 2. Such conditions may be determined by the characteristics of more than one illumination sources. One illumination source that may affect the uniformity of the aforementioned absorption and therefore cause to inconsistency in the reading of a certain illuminated label is a fluorescent-based light source, such as a fluorescent lamp. As commonly known, a fluorescent-based light source, such as a fluorescent lamp, that operates directly from mains frequency alternating current (AC) flickers at twice the mains frequency. For clarity, the light of such a lamp flickers at 120 times per second (Hz) in countries which use 60 Hz AC, and 100 times per second in those which use 50 Hz AC.

In order to avoid inconsistency in the reading of labels which are illuminated by a fluorescent light source, the photoelectric sensor 4 is designed to absorb one or more of the monochromatic light beams 5, 6, 7 during a period that is longer than a cycle time of a fluorescent-based light source. Optionally, a series of illumination cycles are measured during this period. The absorbed light is then analyzed and the absorption that indicates on the lowest effect of the fluorescent illumination is identified, for example the absorption that has the lowest illumination intensity. In another embodiment of the present invention, the fluorescent illumination in the surrounding of the area of interest 2 are measured during an idle mode and the measurements are used for neutralizing the effect of the fluorescent illumination from the absorption of light which are performed by the photoelectric sensor 4. Optionally, these measurements are used for identifying which absorption from the aforementioned series of absorptions has not been affected, or has been minimally affected, by the fluorescent illumination. Optionally, the reader device 1 includes an additional photoelectric sensor (not shown) which is used for measuring the illumination conditions in the surrounding of the area of interest 2 and to use the measurements as described above.

In one embodiment of the present invention, the color property output is matched with information that is stored in a storage unit within the reader device or, for example, in a memory card that is accessed by a designated slot of the reader device. Preferably, the reader device identifies labels according to the electromagnetic spectrum of reflections thereform. The identification is performed using the stored information. The reader device presents a message according to the identification. In such an embodiment, the presenting is performed by an audio generating unit for generating predefined sounds for each identified label, a display unit for generating predefined images for each identified label, a vibrating unit for generating predefined movements for each identified label, or any combination thereof.

In one embodiment of the present invention, the color-sensing unit is used for operating a number of functions of the reader device 1. Preferably, the operation mode of the reader device 1 is determined according to the outputs of the color-sensing unit. Preferably, the reader device 1 is designed to work in three working modes:
(a) An active mode—an operational mode in which the reader device illuminates the area of interest and intercepts light waves.
(b) An idle mode—a reduced power consumption mode in which the reader device does not illuminate the area of interest however does intercept light.
(c) An off-power mode—a mode in which no power is supplied to the components of the reader device 1.

In such an embodiment, the outputs of the color-sensing unit are used for switching between working modes. If the photoelectric sensor 4 of the color-sensing unit intercepts light below a certain level, when the light source 3 is idle, it is assumed that the reader device 1 is directed toward or covers a label that users desire to read. In such a case, the reader device 1 is switched to an active mode. However, if the same outputs are produced by the color-sensing unit for a predefined amount of time, for example 30 seconds, it is assumed that the user has positioned the reader device 1 in a dark place, such as bag or a drawer, and the reader device 1 is switched to an idle mode or an off-power mode. Preferably, if the color-sensing unit produces the same output, without a change or a substantial change, for a long period, the reader device 1 switches to an idle mode or an off-power mode in order to reduce the power consumption.

In one embodiment of the present invention, the reader device 1 further comprises a light guide unit 10 for guiding the emitted light 5 to the area of interest 2. Preferably, the light guide unit 10 condenses the light emitted from the light source 2 to a light beam that illuminates a limited area of interest 2. In such a manner, the light source unit 3 is used for illuminating a relatively small area of interest 2, such as a label. Preferably, the illuminated area is an 8-millimeter wide area. Preferably, light guide unit 10 allows the reader device 1 to read labels even when it is inclined in an acute angle, approximately between 50° and 90° in relation to the plane of illuminated label. In such an embodiment, the user may incline the reader device 1 at any angle approximately between 50° and 90° in relation to the plane of illuminated label during the reading of a certain label.

In one embodiment of the present invention, the reader device 1 is a disposable unit.

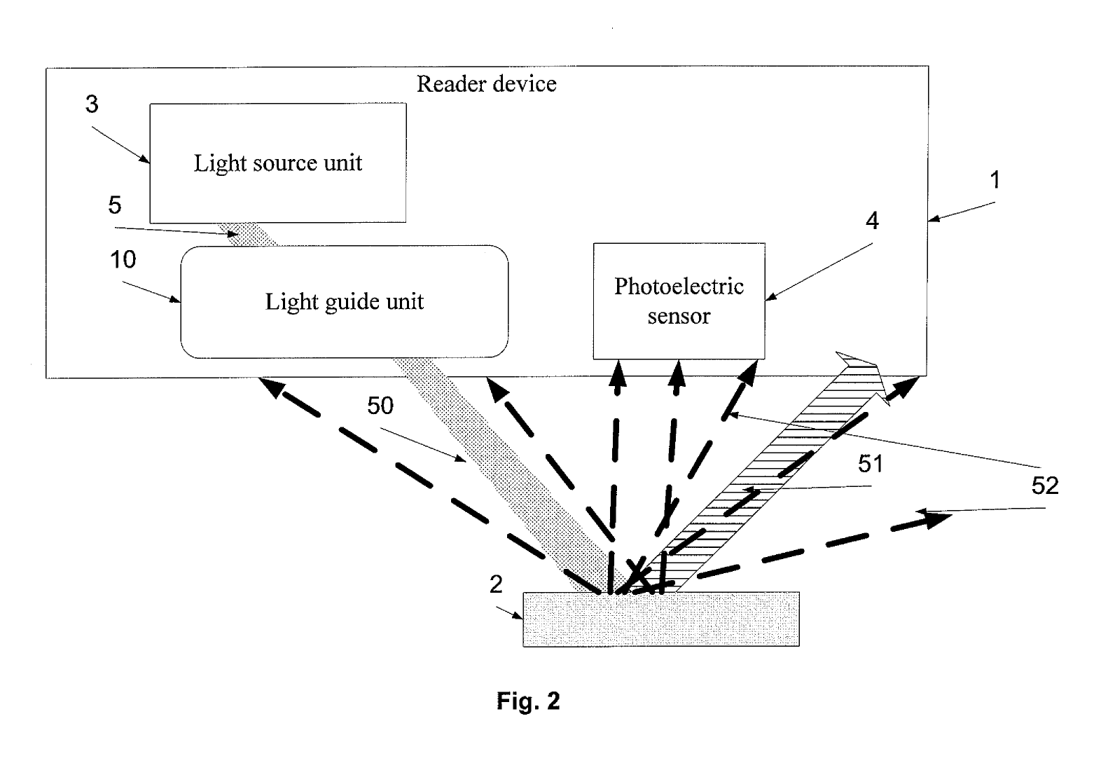

Reference is now made to FIG. 2, which is a schematic illustration of the reader device 1 of FIG. 1 having a light guide unit 10, according to one embodiment of the present invention. The light source unit 3, the area of interest 2, and the photoelectric sensor 4 are as in FIG. 1, however FIG. 2 further depicts the diversion of a light 50 by the light guide unit 5 and specular and diffuse reflections 51 52 of the diverted light.

As depicted in FIG. 2, the light emitted from the reader device 1 is reflected from the surface in the area of interest 2 toward the photoelectric sensor 4. As commonly known, the reflection of light may be either a specular reflection 51, from a smooth surface, which maintains the integrity of the incident wave-front, a diffuse reflection 52, from a rough or irregular surface, which does not maintain the integrity of the incident wave-front, or both, depending on the nature of the surface in the area of interest 2.

According to the law of reflection, the specular reflection is the perfect, mirror-like reflection of light from a surface, in which light from a single incoming direction is reflected into a single outgoing direction. This is commonly stated as θᵢ=θᵣ, where θᵢ denotes the angle of incidence and θᵣ denotes the angle of reflection. This is in contrast to diffuse reflection, where incoming light is reflected in a broad range of directions.

In one embodiment of the present invention, θᵢ denotes the angle of incidence of the light emitted from the light source 3 in relation to the area of interest 2 and θᵣ denotes the angle of the reflection of the light from the area of interest 2. Clearly, θᵢ and θᵣ depends on the distance between the light source 3 and the area of interest 2. Thus, the positioning of the reader device 1 determines the values of angles θᵢ and θᵣ.

In one embodiment of the present invention, as described above, the reader device 1 is used for identifying labels. In such an embodiment, the photoelectric sensor 4 measures the wavelength of the reflections of the light emitted from the area of interest 2, which reflections are divided into a specular reflection, a diffuse reflection, or both, as described above.

If the light emitted from the light source is not diverted, the intensity of the intercepted specular reflection may be dependent on the position of the reader device 1 in relation to the area of interest 2. In such an embodiment, if θᵢ+θᵣ equals or almost equals the angle formed between the light source unit 3, the area of interest 2, and the photoelectric sensor 4, the photoelectric sensor 4 intercepts most of the specular reflection. However, if θᵢ+θᵣ is not almost equal to the angle formed between the light source unit 3, the area of interest 2, and the photoelectric sensor 4, the photoelectric sensor 4 does not intercept the specular reflection or intercepts very little therefrom. Thus, as the intensity of the specular reflection is a derivative of the position of the reader device 1 the outputs of the photoelectric sensor 4, which are preferably a photovoltaic current that is a derivative of the intercepted reflections from the area of interest 2 is effected by the position of reader device 1. Thus, if the light emitted from the light source is not diverted, the photovoltaic current may be dependent on the position of the reader device 1 in a manner that substantially increases the positional sensitivity of the reader device 1. In order to neutralize the effect of the specular reflection on the reader device 1, thereby to reduce the positional sensitivity thereof, the light emitted from the source light 2 is diverted, as shown at 50, in a manner such that the specular reflection 51 is diverted away from the photoelectric sensor 4. Such a diversion allows a relatively uniform output to a reading of a certain label, regardless to the effect of the angle of the photoelectric sensor 4 in relation to the area of interest 2. Such a reading ability allows a user, inter alia, to position the reader device 1 in different angles and distances in relation to the label he or she desires to read.

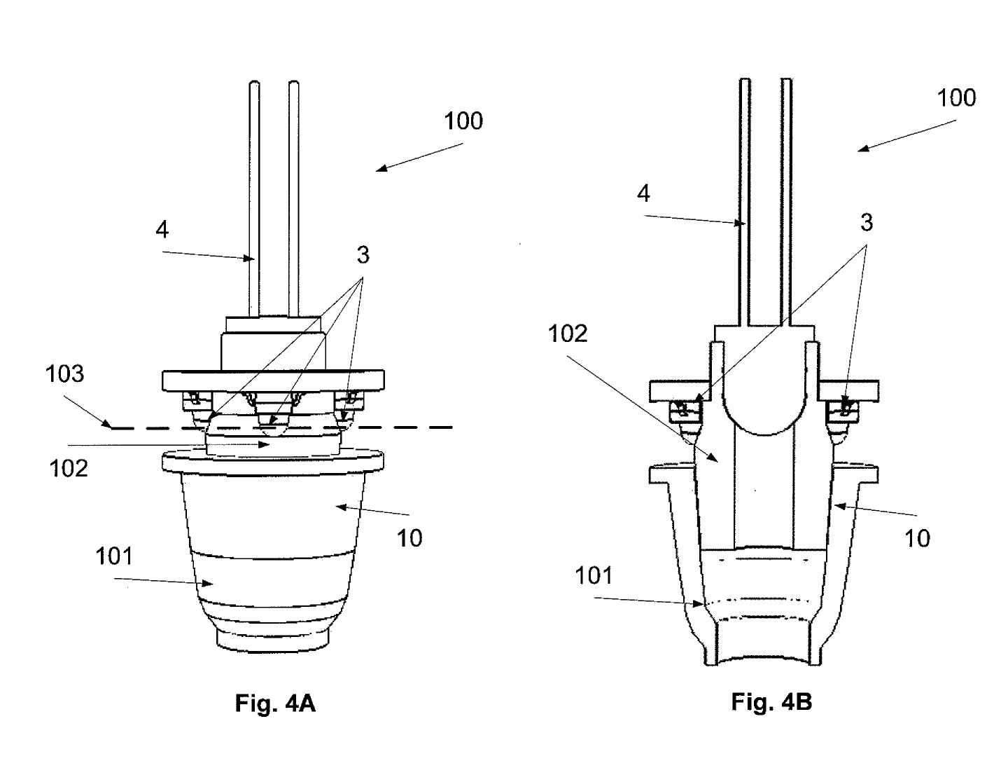

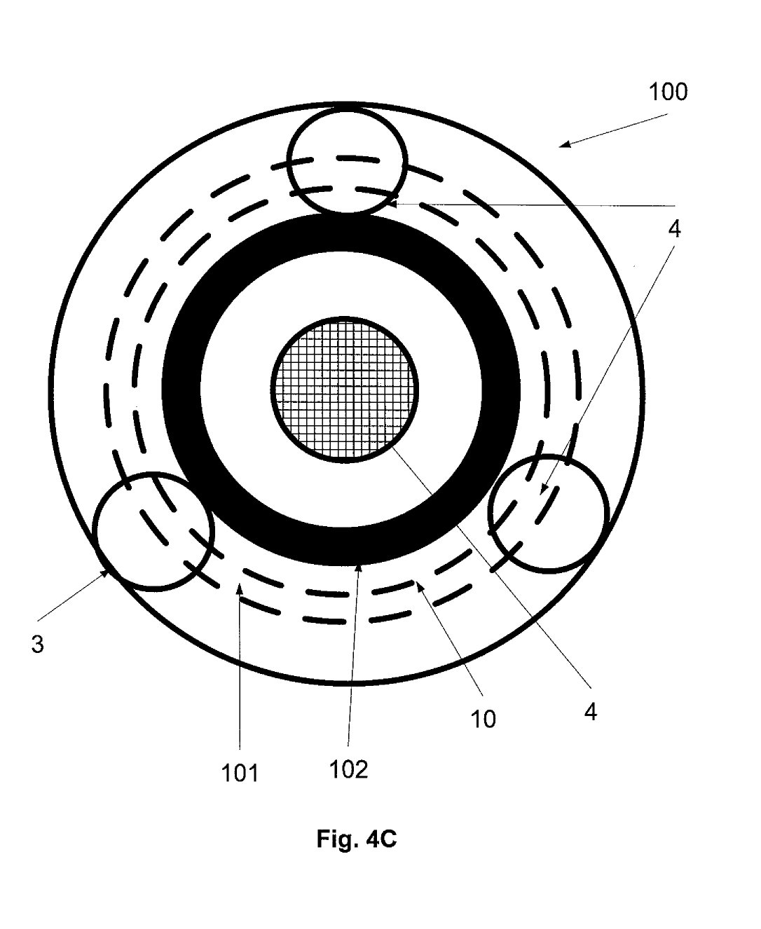

Preferably, the light guide unit 10 guides emitted light in a manner that at least a portion of the specular reflection 51 is diverted away from the photoelectric sensor 4, regardless of the positioning of the reader device 1 in relation to the area of interest. Preferably, as further described below and depicted in 10 of FIG. 4A, a tubular light guide 10 is used for diverting the light. In such an embodiment, the outputs of the photoelectric sensor 4 are based mostly on the intercepted diffuse reflection 52 and the aforementioned effect of the specular reflection 51 is reduced.

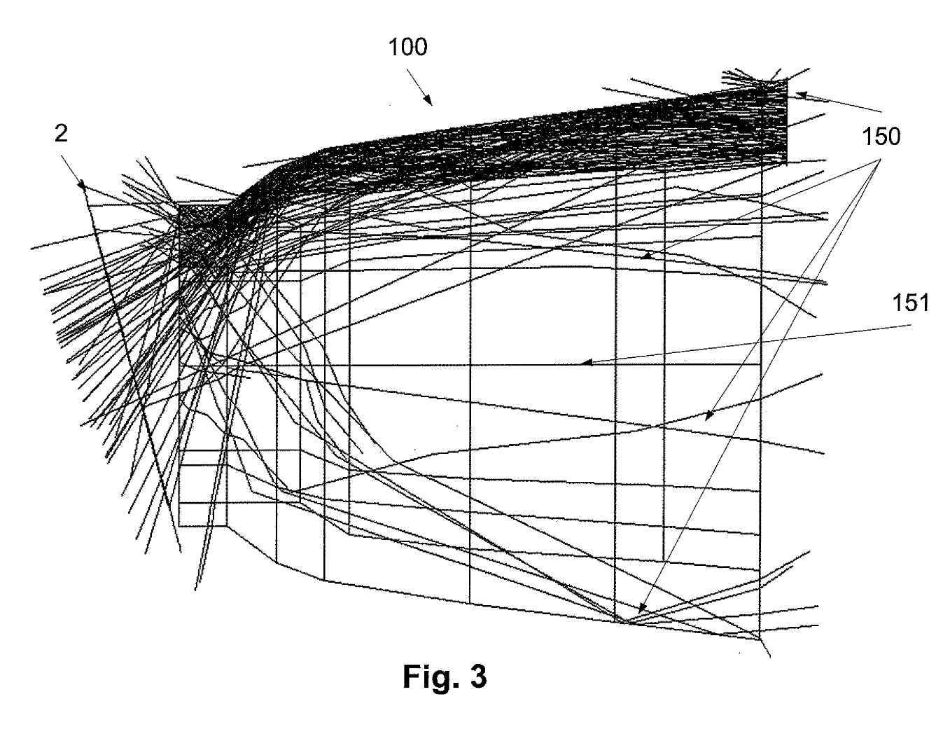

Reference is now made to FIG. 3, which is a schematic illustration of the light guide 10 and exemplary illustration of the path of light that passes therethrough, according to one embodiment of the present invention. As described above the light 150 emitted from the light source 2 is diverted by light guide 10 in a manner that at least a portion of the specular reflection is diverted away from the photoelectric sensor. The light guide 10, preferably has a tubular cone shape, and is designed to encircle the line of sight of the photoelectric sensor. As depicted, the light guide 10 guides the light toward the area of interest 2 in a manner such that the angle of reflection of most of the reflection is not directed toward a tubular light guide pore 151 in the middle of the tubular cone but rather toward the walls of the tubular cone and the external surrounding. In such a manner, the photoelectric sensor may intercept diffuse reflections from the area of interest.

Reference is now made to FIG. 4A, which is a schematic representation of a color-sensing unit 100 that comprises the photoelectric sensor 4, the light guide unit 10, and the light source unit 3 of the reader device and to FIG. 4B, which is a sectional view of the color-sensing unit 100, both according to one embodiment of the present invention. In the depicted embodiment, the photoelectric sensor 4 is a single photodiode that produces, as a result of the absorption of photons, a photovoltage, as described above. The light source unit 3 comprises three LEDs, preferably a red, green, and blue.

As described above, the light guide unit 10 reduces the effect of the specular reflection on the photodiode 4. The light guide unit 10 preferably comprises two parts. The first part is a tubular light guide 101 for guiding the light emitted from the LEDs 3 toward the area of interest 2 and the second part is a light separator 102 for delimiting the absorption area of the photodiode 4 and for blocking direct light from the LEDs 3.

Preferably, the light separator 102 is a tubular segment, which is made from or coated with an absorbing light material, such as a matte, preferably black, plastic tubular segment. Preferably, the light separator 102 is designed to absorb photons that hit its outer or inner boundaries, thereby promising that light, which is diverted from the tubular light guide 101, does not reach the photodiode 4.

As depicted, the photodiode is positioned in the center of the color-sensing unit 100 and the LEDs are positioned around the perimeter of its light sensing segment. For clarity, FIG. 4C depicts an upper view of the color-sensing unit 100 that demonstrates the positioning of the photodiode 4 and the LEDs 3. The tubular light guide 101 guides the light emitted from the LEDs to the area of interest 2 in a manner that the specular reflection is diverted away from the light sensing segment of the photodiode 4. Such guiding is achieved as the light guide diverts the light emitted from the LEDs in such a manner that the angle of incidence defines the angle of reflection so as not to point the reflection toward the light sensing segment of the photodiode 4. The diversion is determined according to the distance between the LEDs 3 and the light sensing segment of the photodiode 4. It should be noted that using the depicted light guide allows the positioning of the area of interest on the label in a manner such that the deviation between the center of the label and the center of the area of interest is up to 25% from the radius of the label. Preferably, the radius of the labels is wider than as the radius of head of the reader device 1. Such an embodiment allows the positioning of the area of interest on any section of the label and therefore the user is not required to aim accurately the head of the reader device 1 toward the center of the label.

In one embodiment of the present invention, the reader device 1 further comprises a label detection sensor. Such a label detection sensor is preferably positioned to intercept light via the light guide 10, for example on a common axis with the LEDs 103. Preferably, the labels are designed as a colored circle that is encircled with a black ring. In such an embodiment, when the center of the area of interest of the reader device is positioned on the label, the label detection sensor is positioned in front of the black ring. As the black ring does not, or approximately does not, reflect light, the label detection sensor does not, or approximately does not, intercept light.

Preferably, if the label detection sensor intercepts light below a certain level, it is assumed that the reader device 1 is directed toward or covers a label that a user desires to read. In such a case, the label detection sensor notifies the reader device 1 to read the label, as described above.

In some embodiments of the present invention, the label depicts a calibration pattern that is used for calibrating the reading of the label by the reading device. Optionally, the calibration pattern is a color segment having a maximal reflection of light that is centered on a certain wavelength, for example blue. Optionally, the calibration pattern is read during a preliminary illumination cycle that occurs before the reading illumination cycles. The absorption of reflections which are centered on the certain wavelength, which may be referred to herein as calibration values, may be used, inter alia, for normalizing the measurement of the light that is reflected from the label. The calibration values may be used as a reference value that is used for correlating the absorbed light. Optionally, the calibration values are used for compensating for the low intensity of light that is reflected from the area of interest 2 when the reading device 1 is not exactly or substantially diverted toward of the area of interest 2.

Optionally, the reading device 1 is designed for identifying a plurality of calibration patterns, as described above, which are assimilated into a single color label. In such an embodiment, each one of the plurality of calibration patterns may be used as a reference value for reading light beams having a wavelength in a range of values around the calibration pattern. In such an embodiment, the color label is identified by identifying the plurality of calibration patterns and using them as references for the reading light that is reflected from other segments of the label.

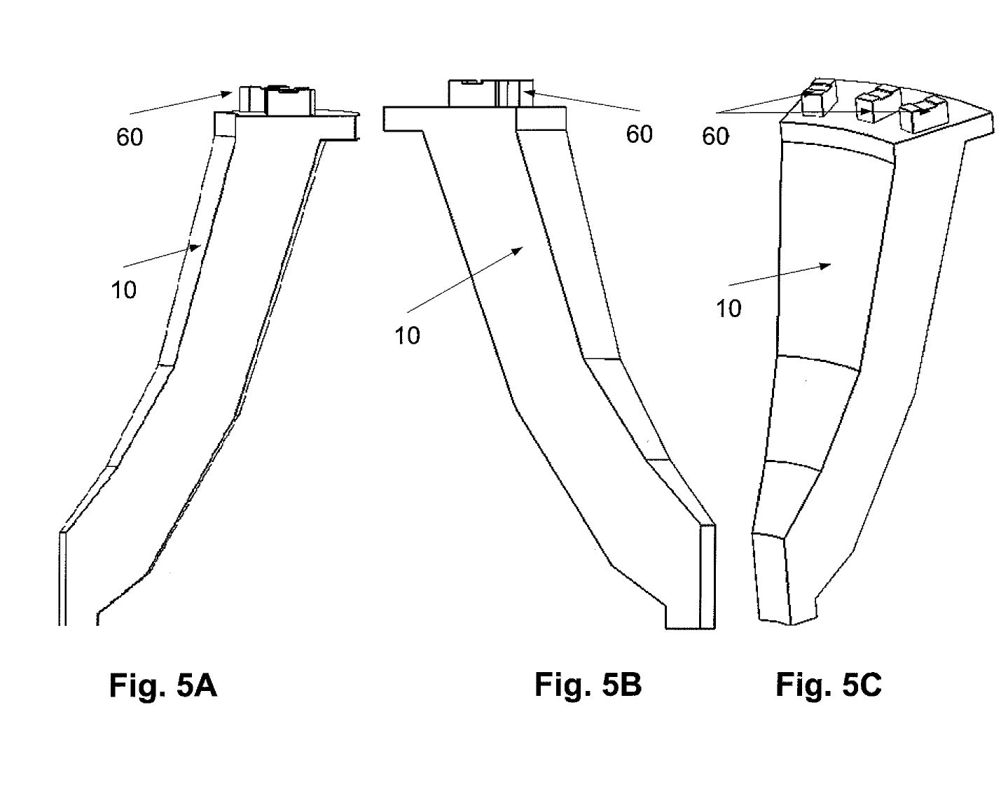

Reference is now made to FIGS. 5A, 5B, and 5C, which are schematic illustrations, each from a different point of view, of another exemplary light guide 10, according to another embodiment of the present invention. The exemplary light guide 10 is designed to guide light beams from two or more light emitting elements, such as LEDs, via a common path, toward the area of interest. As all the light beams are directed via a common path, the angle of incidence of each one of them, with respect to the label, is approximately the same. Clearly, the angle of reflection of each one of the light beams is also approximately the same. Such an embodiment allows the positioning of the reader device 1 in various angles in relation to the label's plane without changing the ratio between the angles of incidence of light beams from different light emitting elements.

In the exemplary light guide 10, which is depicted in 5A, 5B, and 5C the light beams from three different light emitting elements, such as R, B, and G LEDs, are guided in approximately the same path toward a common area of interest. The light guide 10 comprises three projections 60, each for a different light emitting element. The projections 60 are shaped with a niche that allows the positioning of the light emitting element head therein. The light guide 10 is shaped as a longitudinal segment of a tubular cone. The unique shape of the light guide 1 condenses the light that passes therethrough to a common area of interest. As the lights from all the light emitting elements reaches a common area of interest, the reflections thereof are relatively uniform. In such a manner, the intensity of the reflections, which are intercepted by the photodiode, are relatively uniform for light from any of the light emitting elements. It should be noted that though the light guide 10 comprises only three projections for three light emitting elements, the light guide 10 may comprise any number of projections, respectively, to the number of the light emitting elements.

As described above, using a number of light emitting elements for emitting a number of different light beams, each centered on a different wavelength, such as infrared, red, green, blue, and ultraviolet, allows the reading of labels that have a nonuniform pattern with a single label detection sensor. The single label detection sensor may be used for detecting segments with different color or hue in such a nonuniform label. Optionally, the reader device 1 is used for reading the segments in a certain order, for example from right to left, measuring the different segments one by one. In such an embodiment, the order of the segment in the label, the color and/or the hue of the segments of the label, and/or a combination thereof may be used for encoding data that is associated with the label. Clearly, such a combination increases the number of possible labels and/or the amount of information that may be represented by a single label.

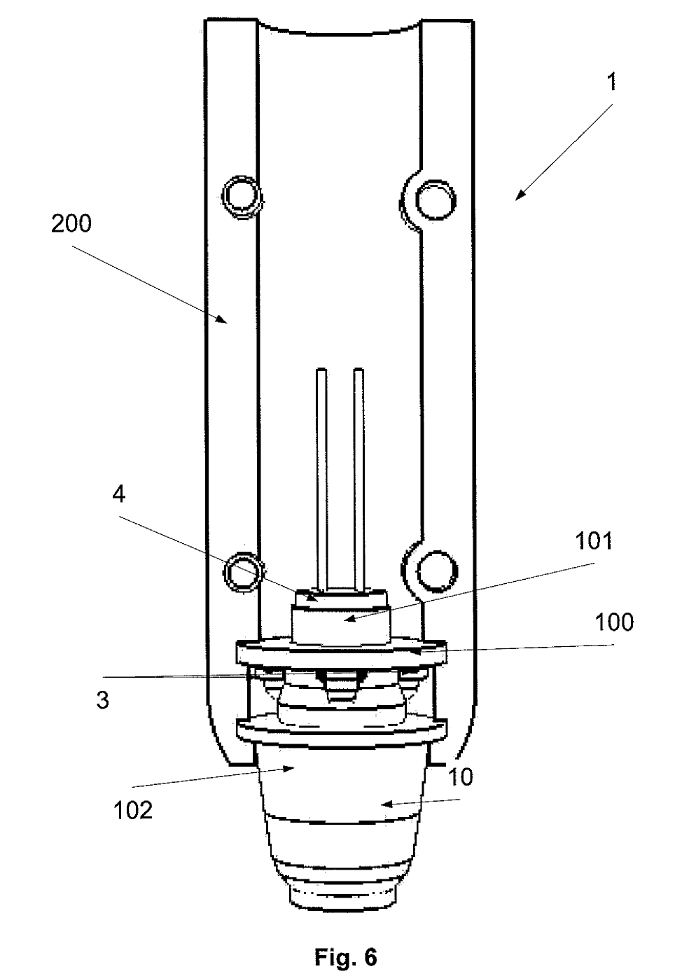

Reference is now made to FIG. 6, which is a sectional view of a housing 200 that substantially encloses all the elements of the reader device 1 and a view of the color-sensing unit 100, which is depicted in FIG. 4A and integrated in the aforementioned reader device, according to one embodiment of the present invention. As described above, the reader device 1 reads labels, which are printed on a certain object, such as a product or a document.

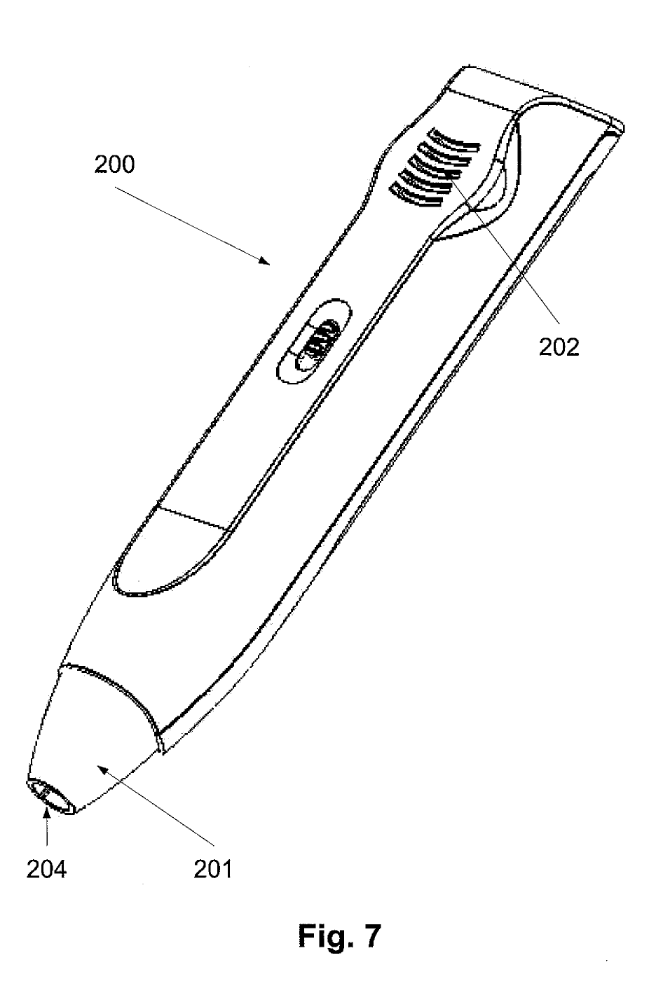

As depicted in FIG. 6, the color-sensing unit 100 is positioned at the end of the reader device 1. The reader device 1 comprises housing 200 that is shaped as a writing tool with an ergonomic handle, for example as shown at FIG. 7. The color-sensing unit 100 is stored within the housing 200 having the light sensing segment of the photodiode 4 directed toward the end of the housing 201, for example as shown at FIG. 7. The ergonomic handle allows a user, preferably a child, to grab the reader device 1 in such a manner that he or she may easily direct the light sensing segment of the photodiode 4 and the emitting segment of the light source 3 toward a label that represents desired information, as described above.

As the reader device 1 is shaped as a writing tool, the user directs the end thereof toward the label that represents the information that he or she desires to present. In one embodiment of the present invention, the presentation is performed by playing an audio file that is associated with the label. In such an embodiment, a speaker, as shown at 202 of FIG. 7, is used as an acoustic output means for playing the audio file.

Optionally, the reader device 1 includes a pressure switch 204 and/or a proximity sensor that senses when the user directs the end of the reader device 1 toward the area of interest 2 and activates and/or deactivates the light source 3 and/or the photoelectric sensor 4 accordingly. In such an embodiment, the light source 3 and/or the photoelectric sensor 4 are deactivated as long as the reader device 1 is not directed toward a surface or any other region that may include a label, optionally as described above. Optionally, the pressure switch 204 and/or the proximity sensor activates the light source 3 and/or the photoelectric sensor 4 only when the reader device 1 is positioned in a manner that the light that is absorbed by the photoelectric sensor 4 is reflected from the area of interest 2 and/or from a segment thereof and not from the surrounding of the area of interest 2. In such a manner, the pressure switch 204 and/or the proximity sensor are used as a mechanism that ensures that the reading of the reader device 1 is performed only when the reader device 1 is accurately positioned above the label. As described above, the light source 3 may include a number of LEDs. In some embodiments of the present invention, the reader device 1 performs a preliminary illumination cycle before the aforementioned reading is performed and/or the color-sensing unit 100 is activated. During the preliminary illumination, one of the LEDs of the light source 3, optionally an IR LED with relatively low power consumption performs a preliminary illumination. Then, the photoelectric sensor 4 absorbs the reflected light and estimates whether the intercepted light has been emitted from an area of interest 2 that includes a label or a segment thereof.

As described above, the reader device 1 is designed to read labels in various angles in relation to the area of interest. The guide light unit 10 is designed to guide the light from the LEDs 3 toward the area of interest in a manner that allows the diversion thereof in an angle of up to 50° in relation to the plane of the area of interest.

In use, the user positions the reader device 1 in the proximity of the label in a manner such that the area of interest 2 is on the label he or she desires to read, and the label is in front of the aforementioned light sensing and light emitting segments. During the reading of the label, the reader device 1 activates the LEDs that illuminate the area of interest 2 in response. Preferably, during each reading, the red, the green, and the blue LEDs are activated separately in three or more sequential illuminations sessions. In such a manner, the area of interest 2 is flashed sequentially, one or more times, by light with wavelengths in different ERS and the reflection of the flashes illuminates the photodiode 4 with respective reflection. The photodiode 4 generates a photovoltaic value for each one of the three illumination flashes and forwards the photovoltaic value to a computing unit (not shown) of the reader device 1. The combination of the photovoltaic values provides a color property output of the tested surface in the area of interest 2. In such a manner, the reader device 1 may analyze the photovoltaic values, either separately or jointly, to identify the mark or the label in the area of interest 2.

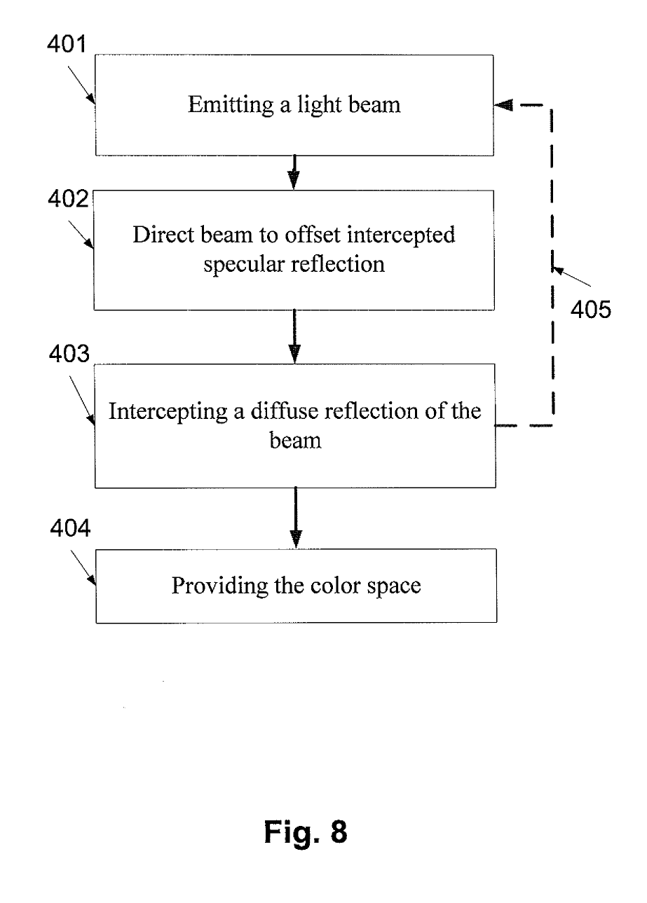

Reference is now made to FIG. 8, which is a flowchart of a method for identifying a color property in an area of interest using a photoelectric sensor, such as a photodiode, according to one embodiment of the present invention. As shown at 401, a beam of light is emitted in the first step. Preferably, as described above, the beam of light is emitted from a light source such as a LED. Then, as shown at 402, the beam is diverted toward the area of interest in such a manner that the specular reflection of the beam is diverted away from the photoelectric sensor. As described above, such a beam diversion may be performed using a designated light guide, for example as depicted in FIG. 7. During the following step, as shown at 403, the photoelectric sensor intercepts at least a portion of the diffuse reflection of the light beam, from the area of interest. Then, as shown at 404, the photoelectric sensor generates the requested color property output according to the intercepted reflection. Preferably, as described above, the light source is designed for transmitting light beams in different wavelength bands. In such an embodiment, as shown at 405, steps 403-404 are repeated sequentially for each one of the light beams. Preferably, the color property output is defined according to the intercepted reflection of each one of the beams.

In one embodiment of the present invention, the method for identifying a color property is used for identifying a label and presenting content that is associated with the identified label. In such an embodiment, the user positions the reader device in the proximity of a label that represents the content he or she desires to present, in such a manner that the label is in the area of interest. The color property in the label is identified, as described in steps 401-404, and a color property output is generated in response. The reader device chooses a matching content according to the color property output. The matched content is presented by playing an audio file, displaying a video file, displaying a text message, activating a vibrating unit, activating a light source or changing the color emitted therefrom after the color property or a certain label is identified, as described above.

It is expected that during the life of this patent many relevant devices and systems will be developed and the scope of the terms herein, particularly of the terms light guide, photodiode, sensor, and reader is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1-39. (canceled)

40. A reader device for identifying a label on an object, said reader device comprising:
a light source unit (3) configured for emitting a plurality of substantially monochromatic light beams centered on different wavelengths;
a single photoelectric sensor (4);
a light guide shaped and positioned for guiding each said substantially monochromatic light beam from said light source unit (3) toward the label said object such that a respective specular reflection from the label is directed away from said single photoelectric sensor (4) and at least a portion of a respective diffuse reflection from the label is directed toward said single photoelectric sensor;
a processing unit for matching a color property of the label with a content record according to at least one output of said single photoelectric sensor; and
a presentation unit for presenting said matching content record.

41. The reader device of claim 40, further comprising a light guide unit (10) for guiding each of said plurality of monochromatic light beams to an area of interest, said label being positioned in said area of interest.

42. The reader device of claim 41, wherein said light guide unit (10) is configured for condensing each of said plurality of monochromatic light beams to the vicinity of said area of interest.

43. The reader device of claim 41, wherein said light guide unit (10) comprises a light separator for blocking direct light from said light source unit (3).

44. The reader device of claim 41, wherein said light guide unit (10) comprises a light separator for delimiting the absorption area of said photoelectric sensor.

45. The reader device of claim 40, wherein said light source unit (3) is configured for consecutively emitting said plurality of monochromatic light beams.

46. The reader device of claim 41, wherein said light guide unit (10) is a tubular light guide.

47. The reader device of claim 40, wherein said photoelectric sensor (4) is a single photodiode.

48. The reader device of claim 40, wherein said light source unit (3) comprises a plurality of light emitting diodes (LEDs) (3) having different emission wavelengths.

49. The reader device of claim 48, wherein said plurality of LEDs (3) encircle said photoelectric sensor, said device further comprising a tubular separator for preventing said single photoelectric sensor (4) from intercepting said plurality of monochromatic light beams.

50. The reader device of claim 48, wherein said plurality of LEDs (3) comprises a red LED, a green LED, a blue LED, an infrared (IR) LED, and a white light LED.

51. The reader device of claim 48, wherein said light source unit (3) is configured for activating one of said plurality of LEDs for estimating the presence of said label in front of said single photoelectric sensor (4) before said emitting.

52. The reader device of claim 41, wherein said light guide unit (10) is configured for guiding said plurality of substantially monochromatic such that the luminance distribution of the reflection of each one of said plurality of monochromatic lights being relatively uniform.

53. The reader device of claim 40, wherein said processing unit being configured for analyzing the intensity of the color property and determining a working mode of the reader device accordingly.

54. The reader device of claim 40, further comprising a label detection sensor adapted for detecting the presence of a label in front of said single photoelectric sensor.

55. The reader device of claim 40, wherein said single photoelectric sensor (4) further comprises a number of additional photoelectric sensors for intercepting another portion of said reflection and measuring the color property according to said another portion.

56. The reader device of claim 40, wherein said light guide is positioned to allow a user to use said device reader in an acute angle between 50° and 90° in relation to the plane of said label.

57. The reader device of claim 40, wherein said single photoelectric sensor (4) is configured for receiving said respective diffuse reflection during a period that is longer than an illumination cycle time of said light source unit (3), thereby reducing the effect of a fluorescent illumination on said portion, said single photoelectric sensor (4) being configures for generating said at least one output according to said reduction.

58. The reader device of claim 40, wherein the label comprises a plurality of segments each having a different color, each said monochromatic light beam is emitted toward one of said plurality of segment.

59. The reader device of claim 40, further comprising a proximity detection element for detecting the positioning of said reader device in a proximity to the label, said proximity detection element being configured for activating at least one of said light source unit (3), single photoelectric sensor, and presentation unit.

60. The reader device of claim 59, wherein said proximity detection element is a pressure switch.

61. The reader device of claim 40, wherein the label comprises a plurality of segments each having a different color, said light source unit (3) being configured for emitting said plurality of substantially monochromatic light beams toward each said segment, said single photoelectric sensor (4) configured for measuring the color property according to light reflected from each said segment, the color property is defined according to the order of said plurality of segments.

62. The reader device of claim 40, wherein the label comprises a calibration segment, said single photoelectric sensor (4) being configured for generating said at least one output according to said calibration segment.

63. The reader device of claim 62, wherein said calibration segment having a maximal reflection of light that is centered on a certain wavelength in relation to other reflections from the label.

64. The reader device of claim 40, wherein the label comprises a calibration segment, said single photoelectric sensor (4) being configured for at least one of normalizing said at least one output according to said calibration segment and normalizing said color property according to said calibration segment.

65. A color-sensing unit for measuring a color property in an area of interest, said color-sensing unit comprising:
a light source for emitting a plurality of substantially monochromatic light beams centered on different wavelengths;
a single photoelectric sensor; and
a single light guide, positioned in front of said light source and sized and shaped for guiding each said substantially monochromatic light beam from said single photoelectric sensor (4) toward the area of interest such that a respective specular reflection of said light beam is diverted away from said photoelectric sensor;
wherein said photoelectric sensor (4) is configured for intercepting and measuring at least a portion of a diffuse reflection of said light beam from the area of interest, thereby providing the color property.

66. The color-sensing unit of claim 65, wherein said light guide has a wall around a tubular pore, said light beam being guided in said wall and said single photoelectric sensor (4) being positioned in front of said tubular pore.

67. The color-sensing unit of claim 65, wherein said light guide has one of a conical shape, a tubular shape, a conical shape, and a shape of a longitudinal segment of a conical tube.

68. The color-sensing unit of claim 65, wherein said plurality of light sources are configured for consecutively emitting said plurality of substantially monochromatic light beams, said photoelectric sensor (4) being configured for providing the color property according to the diffuse reflections from each of said light sources.

69. The color-sensing unit of claim 65, wherein said plurality of light sources comprises at least one light emitting diode (LED).

70. A method for identifying a color property in a label using a photoelectric sensor, said method comprising:
a) emitting a beam of light;
b) directing said beam toward a label on an object in such a manner that the specular reflection thereof is directed away from the photoelectric sensor (4) and at least a portion of a diffuse reflection is directed to the photoelectric sensor;
c) using the photoelectric sensor (4) for intercepting at least a portion of a diffuse reflection of said beam from the label; and
d) providing the color property according to said intercepted reflection.

71. The method of claim 70, further comprising a step c1) of repeating step (a)-(c) using an additional beam of light having a different wavelength bands from said beam of light.

72. The method of claim 70, wherein the photoelectric sensor (4) is a single photodiode.

73. The method of claim 70, further comprising detecting the presence of a label in the label before said a).

74. The method of claim 73, wherein said detecting comprises:
emitting a preliminary beam of light toward the label;
using the photoelectric sensor (4) for intercepting at least a preliminary portion of a preliminary diffuse reflection of said preliminary beam from the label; and
analyzing said preliminary diffuse reflection to determine the presence of a label in the label.
